(19) United States
(12) Patent Application Publication
(10) Pub. No.: US 2004/0053098 A1
(43) Pub. Date: Mar. 18, 2004

(54) Electrochemical cell

(76) Inventors: David Jorge Schiffrin, Wirral (GB); Kyoesti Eero Antero Kontturi, Espoo (FI); Richard John Nichols, Liverpool (GB); Jerzy Paprotny, Liverpool (GB)

Correspondence Address: RATNERPRESTIA, P O BOX 980, VALLEY FORGE, PA, 19482-0980, US

(21) Appl. No.: 10/332,422

(22) PCT Filed: Jul. 3, 2001
(86) PCT No.: PCT/GB01/02972

(30) Foreign Application Priority Data
Jul. 5, 2000 (GB) 00163790

(51) Int. Cl. H01M 8/10; H01M 4/90; H01M 4/92

(52) U.S. Cl. 429/30; 429/43; 429/40; 429/13

(57) ABSTRACT

An electrochemical cell that generates electricity, comprising gas diffusion electrodes and a bipolar membrane electrolyte, is disclosed. The cell may further comprise electrocatalysts. Also disclosed is a process using the cell in the synthesis of chemicals, particularly hydrogen peroxide.

The present invention concerns an electrochemical cell, and a process that uses the cell for the electrochemical synthesis of chemical compounds, particularly hydrogen peroxide.

Hydrogen peroxide is used widely as an environmentally benign oxidising agent. It is used in the pulp and paper, textile and chemical industries and production is approximately 1,000,000 tonnes per annum in Europe. At present hydrogen peroxide is manufactured mainly by a chemical route based on the reduction of an anthraquinone with hydrogen followed by its oxidation with air. The hydrogen peroxide is then. extracted in an aqueous stream and must be further purified to eliminate organic contaminants. The method requires a large-scale installation to be economical and the hydrogen peroxide must be transported to the point of use.

An electrochemical cell for hydrogen peroxide production is disclosed in U.S. Pat. Nos. 5,565,073 and 5,647,968. Oxygen is reduced and water is oxidised in a liquid alkaline electrolyte. The process requires significant input of electrical energy, and the hydrogen peroxide is produced in an alkaline solution (generally a sodium hydroxide solution). Separation of the peroxide from the base is difficult, making the process expensive and inefficient for the production of free hydrogen peroxide. An advantage of this electrochemical process over the anthroquinone process is that it does offer an opportunity to build small on-site hydrogen peroxide generators.

A fuel cell is fundamentally an electrochemical cell formed from two electrodes and an intervening electrolyte. In a fuel cell, the stored chemical energy of a fuel and an oxidant is converted into electrical energy. The fuel is usually hydrogen or methanol, and this is combined with oxygen to produce power. The hydrogen or methanol is oxidised at the anode and oxygen is reduced at the cathode. The electrodes are porous to gas diffusion and are both in contact with the electrolyte. The electrolyte may be liquid or solid, acid or alkaline in nature.

There has recently been a high level of research and development in fuel cell technology. It is envisaged that fuel cells will provide power sources for a wide range of applications, particularly as a replacement for internal combustion engines in vehicles, and in a combined heat and power generator for domestic or other small scale use.

When hydrogen and oxygen are fed into a fuel cell, the reaction at the anode is the oxidation of hydrogen:

2H₂→4H⁺+4e⁻

the reaction at the cathode is the four electron reduction of oxygen:

O₂+4H⁺+4e⁻→2H₂O

and the product of the overall reaction is water:

2H₂+O₂→2H₂O

The Gibbs energy of this reaction is converted to electrical energy.

Hydrogen peroxide can be produced instead of water if the four electron reduction of oxygen is inhibited and the two electron reduction of oxygen at the cathode is promoted:

O₂+2H⁺+2e⁻→H₂O₂

The overall cell reaction becomes:

O₂+H₂→H₂O₂

Again, the Gibbs energy of the reaction is converted into electrical energy, so the synthesis of hydrogen peroxide is accompanied by energy production.

Hydrogen peroxide production using fuel cell technology provides many advantages over the current methods of manufacture. The process is a zero-emission process and no electricity is required to power the cell; indeed energy is produced by the electrochemical cell and can be used to reduce the energy costs elsewhere in a chemical process. The generation of hydrogen peroxide can be achieved in a small modular unit that can be integrated into a larger system. Accordingly hydrogen peroxide can be generated at the point of use and there are no transportation costs or difficulties.

Two distinct approaches have so far been adopted in the development of fuel cells for hydrogen peroxide production. One approach is similar to that adopted in the O₂/H₂O electrochemical cells. A wide variety of electrode surfaces such as carbon, gold and compounds of cobalt are known to promote two electron oxygen reduction in alkaline media, so a liquid alkaline electrolyte is used. An oxygen diffusion electrode is combined with a hydrogen diffusion electrode, and the hydrogen peroxide is produced in the alkaline (usually hydroxide) solution. The generation of hydrogen peroxide in an alkaline fuel cell is described in J. Electrochem. Soc. Vol. 145, No. 10, 3444-3449.

Another approach has followed current fuel cell technology and uses a solid membrane electrolyte. In proton exchange membrane fuel cells (PEMFC), the electrolyte is a solid, proton-conducting polymer membrane. The combined structure of a membrane and two gas diffusion electrodes is known as the membrane electrode assembly (MEA). Electrocatalysts are incorporated on either side of the membrane in the MEA to increase the rates of the desired electrode reactions. Membrane electrolytes are clearly more convenient than liquid electrolytes because they are light and compact, and there are no problems with separating the product from the electrolyte. The most common membranes are based on polymeric perfluorosulfonic acid, eg the commercially available Nafion®. Patent applications WO 97/13006 and WO 95/30474 (both The Dow Chemical Company) disclose an electrochemical cell for hydrogen peroxide synthesis containing a Nafion® based membrane. The choice of cathode electrocatalyst is limited because most known oxygen reduction catalysts promote the four electron reduction of oxygen in acidic media. Electrocatalysts based on metals such as zinc, gadolinium and lanthanum are used because they appear to favour the two electron reduction. Despite careful catalyst choice, the selectivities of the disclosed processes are quite poor (generally below 70 mol %) and only very weak solutions of hydrogen peroxide in water are produced (up to about 4 wt %). In addition, it is likely that the integrity of catalyst 2.5 materials such as zinc would be damaged by the highly acidic electrolyte environment (acid concentrations of over 3 mol/l prevail in the polymer).

It would be desirable to have an electrochemical cell for the production of hydrogen peroxide that employed a membrane electrolyte but could incorporate one of the many electrocatalysts that favour two electron reduction of oxygen in alkaline media Anionic polymer membranes are known but cannot be used because, as stated by Dow in WO 97/13006, conductance of the peroxide anion OH₂⁻ is undesirable. The anion could migrate from the cathode to the anode and be oxidised back to oxygen thus reducing the efficiency of the synthesis. This does not happen when using a cationic membrane because there is no mechanism for the transport of anions.

Bipolar membranes were originally developed about twenty years ago for water S splitting applications. They were used in the production of industrially useful acids and bases from low cost salts of their neutralising products. A bipolar membrane comprises a classical fuel cell acidic membrane (cation-conducting) and an alkaline membrane (anion-conducting). A junction between the membranes maintains electrical continuity. Incorporating a bipolar membrane into an electrochemical cell could provide an alkaline medium for the reduction of oxygen and an acidic medium for the oxidation of hydrogen. The peroxide anion cannot migrate to the anode because it cannot be transported through the acidic membrane.

Accordingly, the present invention provides an electrochemical cell that generates electricity, comprising gas diffusion electrodes and a bipolar membrane electrolyte.

Suitably two gas diffusion electrodes and the bipolar membrane electrolyte are combined in an MEA wherein the bipolar membrane electrolyte is interposed between the gas diffusion electrodes. Preferably the alkaline region of the bipolar membrane is adjacent to the cathode and the acidic region is adjacent to the anode. In a preferred embodiment of the invention the cathode is an oxygen diffusion electrode and the anode is a hydrogen diffusion electrode.

Preferably the electrochemical cell comprises electrocatalysts, and the electrocatalysts are located at the interfaces of the electrodes with the membrane. In a preferred embodiment of the invention the alkaline region of the bipolar membrane contacts an electrocatalyst for the two-electron reduction of oxygen and the acidic region contacts an electrocatalyst for the oxidation of hydrogen.

A further aspect of the present invention provides a process for the synthesis of chemicals using the electrochemical cell of the invention. In a preferred embodiment the invention provides a process for the synthesis of hydrogen peroxide.

The electrochemical cell of this invention primarily affords a method of hydrogen peroxide manufacture, but it is known in the art that fuel cells can be adapted for other chemical syntheses. This is described by Langer and Colucci-Rios in Chemtech (April 1985) 226-233 and by Spillman et al in Chemtech (March 1984) 176-183. It is not intended that the scope of this invention is limited to a process for H₂O₂ synthesis only.

The bipolar membrane may be produced by combining cation and anion exchange membranes. Separate cation and anion exchange membrane material, in both solid and solubilised forms are commercially available. Examples include Nafion membranes from DuPont, Solvay membranes from Stantech, and Flemion membranes from Asahi Glass Co. A suitable technique for combining the membranes is laminating. A number of pre-formed bipolar membranes are also commercially available (see references in Handbook of Industrial Membranes, Keith Scott, Elsevier Advanced Technology, 1995, Oxford, UK). As with most membrane-types, bipolar membranes need to be chemically stable, and for electrochemical applications their ionic resistance needs to be kept as low as possible. Typical ionic resistances are in the range of 0.1-20 Ωcm². Other useful characteristics include a high perm-selectivity (typically >90%) and minimal swelling in the presence of water.

The gas diffusion electrodes comprise conducting porous substrates such as carbon paper (eg Toray TGP-H-60 available from Toray Industries, Japan), woven carbon cloths (such as Zoltek PWB-3 available from Zoltek Corporation, Missouri, USA) and non-woven carbon cloths (as described in EP 0 791 974). Electrocatalysts may be applied to porous substrates before the electrodes are combined with the bipolar membrane. Alternatively, the catalysts may be applied to the membrane before the catalysed membrane is combined with the porous substrates. Suitable techniques for applying the electrocatalysts are well known to those in the art and include printing, spraying and painting.

The catalyst for the oxidation of hydrogen is suitably chosen from those already known in fuel cell technology, eg platinum, palladium, iridium, ruthenium and combinations thereof. Preferably the catalyst is platinum based.

The catalyst for the reduction of oxygen is chosen from those known to promote the two electron reduction of oxgyen and inhibit both the four electron reduction of oxygen and further reduction of the peroxide in an alkaline medium. Catalysts for the cathode reaction are suitably oxides of cobalt and cobalt alloys, functionalised carbon (especially when the surface has been modified, eg by attaching anthraquinone molecules), transition metal complexes (eg cobalt porphyrin), gold, copper, mercury or platinum.

A preferred catalyst for the two electron reduction of oxygen comprises carbon wherein the surface of the carbon has been modified by derivatisation with anthraquinone molecules. Suitably, a compound of formula I is used to derivatise the surface of carbon:

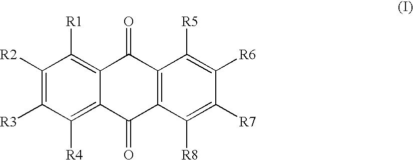

wherein R¹ to R⁸ are independently chosen from C₁₋₁₀ alkyl, C₁₋₁₀ perfluoroalkyl, halogen, nitrate, carboxylate, cyano, sulfonic acid, —SO₂-alkyl, —SO₂-perfluoroalkyl, —SO₂-aryl, —SO₂-perfluoroaryl, hydroxy, O-a l, amine and diazonium ion groups, provided that at least one of R¹ to R⁸ is a diazonium ion group. The diazonium ion group (—N₂⁺) has a suitable counter-ion such as BF₄⁻.

In a particular embodiment, it is preferred that one or more of R¹ to R⁸ is an electron-withdrawing group such as nitrate, carboxylate, cyano, SO₂-alkyl, —SO₂-perfluoroalkyl, —SO₂-aryl, —SO₂-perfluoroaryl or fluorine. In a further embodiment, it is preferred that one or more of R¹ to R⁸ is an electron-donating group such as alkyl, hydroxy, O-alkyl or amine. The choice of particular electron-withdrawing or electron-donating R¹ to R⁸ substituents enables the redox properties of the compound of formula I to be tailored for maximum performance.

To derivatise the surface of the carbon, the diazonium salt of formula (I) is attached to the carbon by electrochemical reduction. The diazonium ion group is reduced to N₂ and a carbon-carbon bond is formed between the benzene ring and the carbon surface. This method for modifying carbon surfaces is described by Allongue et al (J. Am. Chem. Soc., 1997, 119,201-207).

The carbon surfaces may be subjected to physical and/or chemical pre-treatments such as nitric acid oxidation, corona discharge or ozone dosing prior to reaction with compounds of formula I.

In a particular embodiment, the anthraquinone molecules on the surface of the carbon may be polymerised through suitable linking groups.

In a further aspect the invention provides a system comprising an electrochemical cell according to the invention wherein the electricity generated by the cell powers an electrolytic unit for the electrolysis of water and the hydrogen and oxygen thus produced are used as feedstock for the cell. This improves the efficiency of the process and reduces the need for raw materials.

In a yet further aspect the invention provides a system wherein the hydrogen supplied to the cell can be produced as a by-product of another production process or by a reformer unit.

The systems according to the invention are suitably used in processes for the production of hydrogen peroxide.

The invention is further illustrated by reference to the accompanying drawings, in which

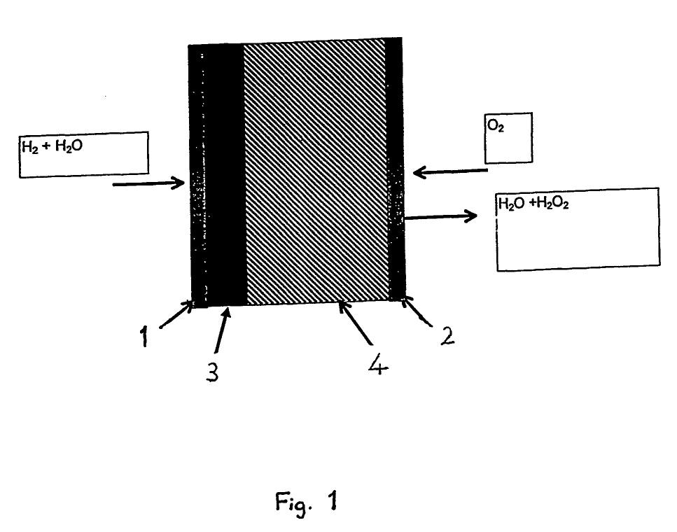

FIG. 1 is a schematic representation of an electrochemical cell according to the invention, and

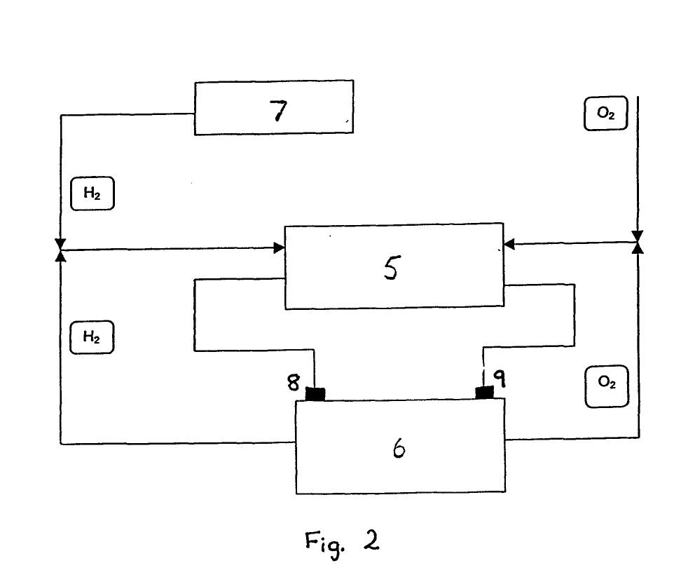

FIG. 2 is a schematic representation of a system according to the invention wherein the energy produced by the electrochemical cell is used to electrolyse water.

In FIG. 1, hydrogen is mixed with water and is fed into the anode 1. An acidic membrane 3, part of the bipolar membrane 3, 4, is adjacent to the anode. The oxidation of hydrogen will take place at the anode, in the acidic environment. The alkaline side 4, of the bipolar membrane 3, 4, is adjacent to a cathode 2. Oxygen is fed into the cathode, and the two electron reduction of water takes place in the alkaline environment. Water and hydrogen peroxide are removed from the cathode. Both the anode 1, and the cathode 2, are gas diffusion electrodes. Electrocatalysts may be present at the anode surface (between 1 and 3) and/or at the cathode surface (between 2 and 4). The anode 1, and the cathode 2, are connected via an electronic circuit.

In FIG. 2, an electrochemical cell for the production of hydrogen peroxide is represented by 5. The electricity generated by 5 powers a water electrolyser 6. Hydrogen is produced at the cathode 8 in the electrolyser and oxygen is produced at the anode 9. The hydrogen and oxygen produced in the electrolyser are transferred to the electrochemical cell 5 where they are reacted to produce hydrogen peroxide. Separate supplies of hydrogen and oxygen also feed in to the cell 5, and the hydrogen may be produced by a reformer unit, 7.

The electrochemical cell of the invention can be manufactured by techniques well known to those who work in the field of fuel cell technology. To operate the cell for hydrogen peroxide production, hydrogen gas, preferably mixed with water vapour (this keeps the conductivity of the membranes within operational limits), is introduced at the anode. Oxygen gas, suitably as a component of air, is introduced at the cathode. Water diffusion will take place across the anode to the cathode and will be carried through the cathode gas stream with the generated hydrogen peroxide. Suitably, a condenser is used to separate the hydrogen peroxide from the water.

1. An electrochemical cell that generates electricity, the cell comprising a hydrogen diffusion anode, an oxygen diffusion cathode and a bipolar membrane electrolyte;
wherein the bipolar membrane electrolyte comprises an alkaline region adjacent to the cathode and an acid region adjacent to the anode; wherein the alkaline region contacts an electrocatalyst for the two-electron reduction of oxygen; and wherein the acid region contacts an electrocatalyst for the oxidation of hydrogen.

2. An electrochemical cell according to claim 1, wherein the electrocatalyst for the two-electron reduction of oxygen comprises one or more of cobalt, a cobalt oxide, a cobalt alloy, carbon, functionalised carbon, a transition metal complex, gold, copper, mercury or platinum.

3. An electrochemical cell according to claim 1 or claim 2, wherein the electrocatalyst for the two-electron reduction of oxygen comprises carbon, the surface of which has been modified by derivatisation with anthraquinone molecules of formula I: 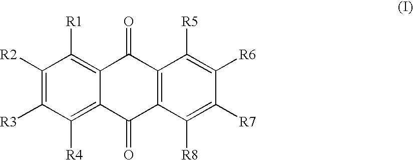
and wherein R¹ to R⁸ are independently chosen from C₁₋₁₀ alkyl, C₁₋₁₀ perfluoroalkyl, halogen, nitrate, carboxylate, cyano, sulfonic acid, —SO₂-alkyl, —SO₂-perfluoroalkyl, —SO₂-aryl, —SO₂-perfluoroaryl, hydroxy, O-alkyl, amine and diazonium ion groups, provided that at least one of R¹ to R⁸ is a diazonium ion group.

4. An electrochemical cell according to any preceding claim, wherein the electrocatalyst for the oxidation of hydrogen comprises platinum, palladium, iridium, ruthenium or combinations thereof.

5. A process for the synthesis of chemicals other than water, the process comprising the use of an electrochemical cell according to any preceding claim.

6. A process for the production of hydrogen peroxide, the process comprising the use of an electrochemical cell according to any preceding claim.

7. An electrocatalyst for the two-electron reduction of oxygen, the electrocatalyst comprising carbon, the surface of which has been modified by derivatisation with anthraquinone molecules of formula I: 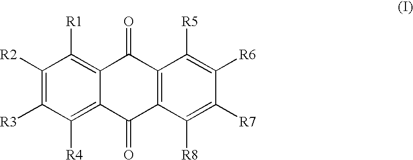
wherein R¹ to R⁸ are independently chosen from C₁₋₁₀ alkyl, C₁₋₁₀ perfluoroalkyl, halogen, nitrate, carboxylate, cyano, sulfonic acid, —SO₂-alkyl, —SO₂-perfluoroalkyl, —SO₂-aryl, —SO₂-perfluoroaryl, hydroxy, O-alkyl, amine and diazonium ion groups, provided that at least one of R¹ to R⁸ is a diazonium ion group.
